(19) United States
(12) Patent Application Publication
(10) Pub. No.: US 2026/0173054 A1
(43) Pub. Date: Jun. 18, 2026

(54) COORDINATED DISTRIBUTED RESOURCE UNITS FOR RATE AND RELIABILITY SUPPORT

(71) Applicant: Cisco Technology, Inc., San Jose, CA (US)

(72) Inventors: Domenico FICARA, Essertines-Sur-Yverdon (CH); Amine CHOUKIR, Ecublens (CH); Roberto MUCCIFORA, Ropraz (CH); Brian D. HART, Sunnyvale, CA (US); Ugo M. CAMPIGLIO, Morges (CH)

(21) Appl. No.: 19/281,655

(22) Filed: Jul. 26, 2025

Related U.S. Application Data
(60) Provisional application No. 63/735,234, filed on Dec. 17, 2024.

(51) Int. Cl. H04W 72/0453; H04W 88/06; H04W 88/08

(52) U.S. Cl. CPC H04W 72/0453; H04W 88/06; H04W 88/08

(57) ABSTRACT

The present disclosure provides techniques for distributed resource unit (RU) coordination. A first access point (AP) determines a plurality of first RU within a frequency channel for use in transmitting data to a client device, where the frequency channel is located within a frequency band and has a defined bandwidth. The first AP coordinates with a second AP to distribute the plurality of first RUs across the frequency channel, where the coordination avoids frequency overlap between the plurality of first RUs assigned to the first AP and a plurality of second RUs assigned to the second AP. The first AP transmits the data to the client device using the plurality of first RUs.

### CROSS-REFERENCE TO RELATED APPLICATIONS

This application claims benefit of co-pending U.S. provisional patent application Ser. No. filed 63/735,234 filed Dec. 17, 2024. The aforementioned related patent application is herein incorporated by reference in its entirety.

### TECHNICAL FIELD

Embodiments presented in this disclosure generally relate to wireless communication. More specifically, embodiments disclosed herein relate to distributed resource unit (RU) coordination across access points (APs) for improved rate and reliability.

### BACKGROUND

Current Wi-Fi operation is subject to power spectral density (PSD) limits imposed by regulatory authorities. These limits constrain the maximum transmit power per unit bandwidth (e.g., dBm/MHz) and are intended to protect incumbent services operating in the band and reduce potential interference. As a result, the total allowable power scales with the occupied bandwidth. For example, when a client transmits over a wide channel to support high data rates, the available power may be spread across more subcarriers, resulting in lower power per subcarrier. The reduced per-subcarrier power leads to a lower signal-to-noise ratio (SNR), which in turn limits the effective transmission range. Therefore, an inherent tradeoff exists: utilizing more bandwidth enables higher throughput but reduces range, whereas using less bandwidth improves range at the cost of lower data rates.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless network environment where multiple devices operate in a shared 6 GHz frequency band, according to some embodiments of the present disclosure.

FIG. 2 depicts an example of interleaved RU allocation across a 160 MHz channel with uniform RU sizes and frequency offsets, according to some embodiments of the present disclosure.

FIG. 3 depicts an example of interleaved RU allocation across a 160 MHz channel with non-uniform RU sizes and frequency offsets, according to some embodiments of the present disclosure.

FIG. 4 depicts an example of skewed RU allocation across a 160 MHz channel between multiple access points (APs), according to some embodiments of the present disclosure.

FIG. 5 depicts an example of a multi-link device (MLD) station (STA) connecting to two APs via separate links, with coordinated RU allocation for data transmission, according to some embodiments of the present disclosure.

FIG. 6 depicts an example method performed by a first AP (AP 1) for coordinating distributed RU allocation with a second AP (AP 2), according to some embodiments of the present disclosure.

FIG. 7 is a block diagram depicting an example method for RU coordination between multiple APs within a shared frequency band, according to some embodiments of the present disclosure.

FIG. 8 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

One embodiment presented in this disclosure provides a method, including determining, by a first access point (AP), a plurality of first resource units (RUs) within a frequency channel for use in transmitting data to a client device, the frequency channel being located within a frequency band and having a defined bandwidth, coordinating, by the first AP with a second AP, to distribute the plurality of first RUs across the frequency channel, wherein the coordination avoids frequency overlap between the plurality of first RUs assigned to the first AP and a plurality of second RUs assigned to the second AP, and transmitting the data, by the first AP and to the client device, using the plurality of first RUs.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### EXAMPLE EMBODIMENTS

The IEEE 802.11bn task group is advancing the next-generation Wi-Fi standard with a focus on achieving ultra-high reliability and enhanced performance, particularly targeting operation in the 6 GHz frequency band. However, regulatory authorities have stated that a threshold for the power spectral density (PSD) should be preserved in the 6 GHz band in order to protect incumbent services. These PSD-related constraints limit the allowable transmit power per unit bandwidth, which impacts the achievable range when operating over wide channels.

PSD is defined as the average transmit power over the entire channel. However, a client device (or a station (STA)) may not require the full channel width for its resource unit (RU) transmission given its traffic demand and application requirements. In such cases, when an AP or STA transmits using only a subset of available RUs, the total power budget can be concentrated into these RUs. For example, if the RU set is one-tenth the size of the full channel, the power per RU can be increased by up to 10 dB.

The present disclosure provides methods, systems, and apparatuses that address the tradeoff between throughput (or rate) and range, and enable more efficient spectral use under PSD constraints by coordinating RU allocation across multiple APs. In some embodiments, RU allocation may be interleaved with a fixed or non-fixed offset between APs to avoid spectral overlap. In some embodiments, the RU allocation may be asymmetrically divided across the spectrum such that each AP occupies a distinct portion of the channel. In some embodiments, the RU allocation may be coordinated between APs for a multi-link device (MLD) STA, where each AP transmits over a different link, and traffic is either aggregated to increase throughput or duplicated to improve reliability. The disclosed coordinated approach allows devices to achieve longer transmission range under the PSD constraints while maintaining sufficient RU resources to support high data rates.

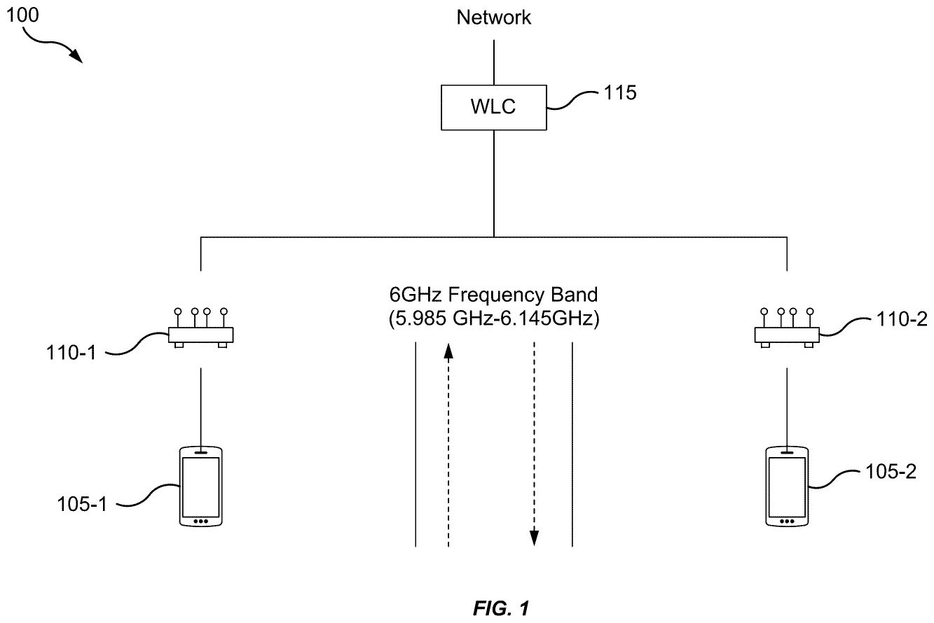

FIG. 1 depicts an example wireless network environment 100 where multiple devices operate in a shared 6 GHz frequency band, according to some embodiments of the present disclosure.

In the example environment 100, a wireless local area network (LAN) controller (WLC) 115 is connected to two access points (APs). Each AP connects to a respective station (STA) (or client device): AP 110-1 connects to STA 105-1, and AP 110-2 connects to STA 105-2. As used herein, the AP 110 may correspond to a single-link AP or an AP multi-link device (AP MLD), and the STA 105 may correspond to a single-link STA or a STA MLD.

In the depicted environment, both APs 110 operate within a shared 160 MHz channel in the 6 GHz band. For example, the shared channel may span from 5.985 GHz to 6.145 GHz (within UNII-5). AP 110-1 communicates with STA 105-1 using a subset of resource units (RUs) within the channel, and AP 110-2 communicates with STA 105-2 using a different subset of RUs. To comply with PSD regulations, where transmit power is averaged across occupied bandwidth (e.g., 160 MHz), each AP 110 may selectively occupy only a portion of the channel and concentrate power in those RUs. The RU allocation is coordinated between APs to prevent overlap and spectral inefficiency. Such distributed RU coordination allows better range performance while still maintaining adequate throughput.

Coordination between APs may occur in multiple ways. In some embodiments, an AP (e.g., AP 110-1) may initiate coordination upon detecting that its associated STA has modest throughput needs and/or limited link margin. As used herein, the link margin is the difference between the received signal strength and the minimum required signal level for reliable decoding. When transmit power is constrained by the PSD limits, particularly over wide bandwidths, the resulting per-subcarrier (or per-RU) power may be insufficient to maintain a strong signal at the STA, leading to a low or reduced link margin. Based on such detection, the AP may send a coordination request to another AP (e.g., AP 110-2) to negotiate RU assignments that avoid spectral overlap and allow the AP to operate on a reduced subset of RUs with higher power concentration. The communication may be performed over the air using management or control frames, such as beacon frames, radio resource management (RRM) frames, trigger frames adapted for RU negotiations, or high efficiency (HE) or extremely high throughput (EHT) operation elements included in management frames.

In some embodiments, the WLC 115 initiates and manages RU coordination between APs. The WLC 115 may monitor real-time network state, including traffic loads and STA link metrics, and assign RU allocation to each AP to avoid spectral overlap. The centralized approach enables global optimization of spectrum usage and range tradeoffs across the network. In some embodiments, a hybrid scheme may be used, where the WLC 115 handles high-level RU allocation, and direct communication between APs is used for fine-grained adjustments based on real-time traffic or channel conditions.

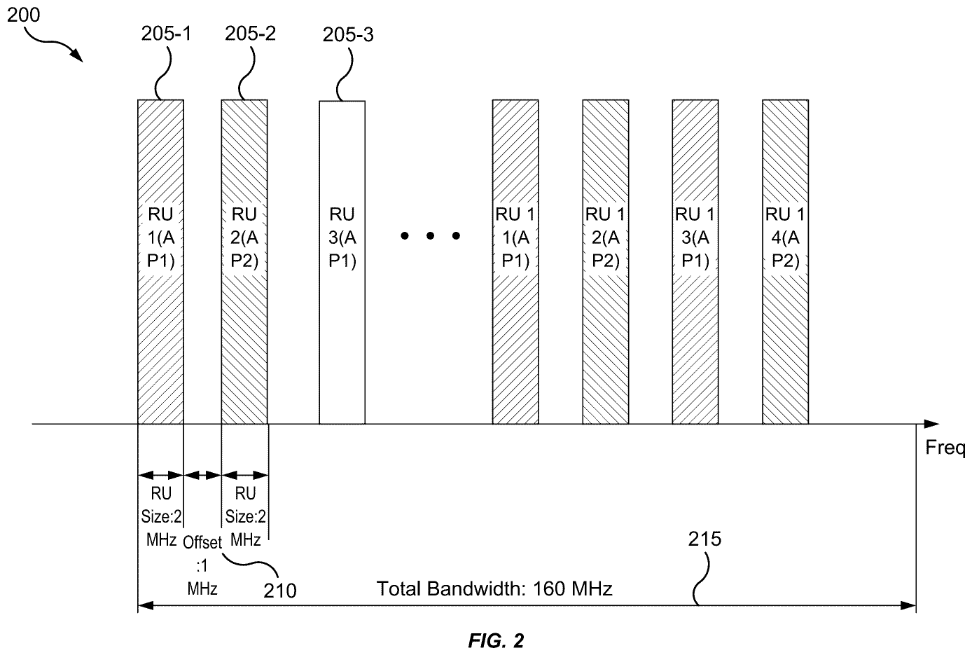

Several coordinated distributed RU schemes may be used to allow each AP to meet its performance objectives under PSD constraints. These may include interleaved RU allocation patterns with fixed or variable offsets between APs, asymmetric (or skewed) RU allocation where each AP occupies a distinct portion of the channel, or coordinated transmission to a multi-link device across separate AP links. Additional details and example embodiments are discussed below with reference to FIGS. 2-5.

FIG. 2 depicts an example of interleaved RU allocation 200 across a 160 MHz channel with uniform RU sizes and fixed frequency offsets, according to some embodiments of the present disclosure.

As depicted, the horizontal axis (x-axis) represents frequency, and a 160 MHz-wide channel 215 is shown in the example. The channel may span over the 6 GHz frequency band (e.g., from 5.985 GHz to 6.145 GHz), as depicted in FIG. 1.

In the example 200, AP 1 and AP 2 share the channel using a uniform RU size and fixed interleaving structure. AP 1 corresponds to AP 110-1 as depicted in FIG. 1, and AP 2 corresponds to AP 110-2 as depicted in FIG. 1. Each resource unit (RU) occupies 2 MHz of bandwidth, and adjacent RUs are separated by a fixed 1 MHz frequency offset 210. The RUs 205 are assigned to two APs. For example, RU 1 (205-1) is assigned to AP 1, RU 2 (205-2) to AP 110-2, RU 3 (205-3) back to AP 110-1, and so on. The pattern continues sequentially up to RU 14 (assigned to AP 2). The number of active RUs assigned to each AP may vary depending on traffic demand, link conditions, or application-specific requirements. In the illustrated example, each AP may occupy any number of RUs up to a maximum of 26 RUs within the 160 MHz channel, such that the entire channel may be fully utilized if needed.

The interleaved RU allocation enables both APs to transmit simultaneously to one or more STAs while maintaining frequency-domain separation and satisfying PSD constraints. For example, in the illustrated example, AP 110-1 occupies seven RUs (RU 1, 3, 5, 7, 9, 11, and 13), each 2 MHz wide, resulting in a total occupied bandwidth of 14 MHz. Under a PSD constraint of 5 dBm/MHz, the total allowed transmit power for AP 110-1 is approximately 16.5 dBm. The power budget is concentrated across just seven RUs, leading to a relatively high per-subcarrier (or per-RU) power.

In contrast, if AP 110-1 were to occupy the entire 160 MHz channel, the total allowed power would be approximately 27 dBm under the same PSD constraint. However, this power would be distributed across a much larger number of RUs, resulting in a lower per-RU power relative to the narrowband case. Therefore, by narrowing its transmission to a limited RU subset under PSD constraints, AP 110-1 can increase its power density per RU (e.g., by around 10 dB), which improves signal quality and extends transmission ranges. The distributed RU approach is beneficial for STAs with lower SNR or located farther from the AP.

To achieve the interleaved RU pattern shown in FIG. 2, coordination between AP 110-1 and AP 110-2 can be used to avoid RU overlap and maintain consistent frequency spacing. The coordination may be performed centrally by the WLC (e.g., 115 of FIG. 1), which assigns non-overlapping RU sets to each AP based on network state, or may be handled directly by APs over the air, using frames such as beacon frames, RRM frames, trigger frames, or extended with HE or EHT operation elements included in management frames.

As mentioned, AP 1 and AP 2 may correspond to AP 110-1 and AP 110-2 as depicted in FIG. 1, where each AP is connected to a different STA (e.g., STA 105-1 and STA 105-2 as depicted in FIG. 1). In this configuration, the interleaved RUs are allocated for downlink (DL) transmissions to two separate STAs, with each AP serving its own associated client using a distinct subset of the channel. In other embodiments, AP 1 and AP 2 may represent separate APs or logical radios operating on different links to the same station multi-link device (STA MLD). In this configuration, the interleaved RU allocation enables coordinated DL transmission to the same STA across multiple links, supporting either traffic aggregation throughput or redundant delivery for improved reliability.

The distributed RU coordination approach is well-suited for DL transmissions. In DL direction, the APs have knowledge of traffic demand, application requirements, and link conditions, allowing the APs to coordinate RU allocation proactively. Since the APs control the scheduling and can determine how to divide the available spectrum, interleaved or segmented RU assignments may be adapted to meet per-STA throughput or range needs.

In some embodiments, distributed RU coordination may also be extended to uplink (UL) transmission, although this may rely on additional signaling and coordination support. For example, STAs may report their RU usage intentions, buffer status, or preferred transmission patterns to the serving AP, which in turn may negotiate UL RU assignments with neighboring APs or via the WLC. Such UL coordination is feasible in scheduled access modes or with trigger-based UL schemes, and enables more efficient spectrum use and reduced contention in high-density deployments.

The uniform RU size of 2 MHz and the fixed offset of 1 MHz illustrated in FIG. 2 are provided for conceptual clarity. These values are provided as examples and not limiting. In some embodiments, the RU size may vary depending on system configuration, channel bandwidth, and device capabilities. For example, RUs may be defined using smaller allocations (e.g., 26-tone RU, approximately 2 MHz) or larger allocations, such as 8 MHz, 20 MHz, or higher.

While FIG. 2 illustrates a fixed offset of 1 MHz between adjacent RUs, other offset sizes may also be used. The offset value may be configured based on desired frequency separation or spectral efficiency goals. The fixed-offset structure remains consistent, but the actual spacing (e.g., 2 MHz, 4 MHz) may be adapted to meet specific deployment requirements.

The illustrated 160 MHz channel 215 is also an example, provided for conceptual clarity. Coordinated distributed RU allocation schemes may be applied across any wide channel bandwidth within the 6 GHz band or other applicable frequency bands.

Although the figure illustrates RU coordination between two APs, the disclosed RU coordination may be extended to more than two APs, to further optimize spatial reuse and spectral efficiency.

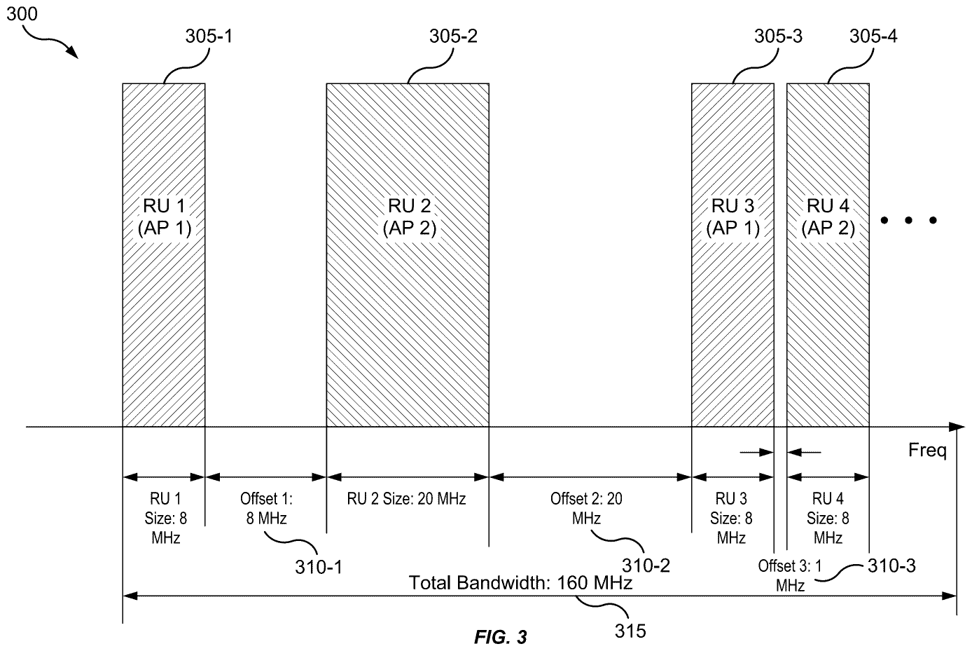

FIG. 3 depicts an example of interleaved RU allocation 300 across a 160 MHz channel with non-uniform RU sizes and variable frequency offsets, according to some embodiments of the present disclosure.

In the example 300, RU sizes and offsets between RUs are non-uniform, but still maintain a coordinated, non-overlapping pattern across multiple APs, including AP 1 and AP 2. The horizontal axis (x-axis) represents frequency, and a 160 MHz-wide channel 315 is depicted. The channel may span a portion of the 6 GHz frequency band, such as from 5.985 GHz to 6.145 GHz, as depicted in FIG. 1.

In the illustrated example 300, RU 1 (305-1) is assigned to AP 1 (e.g., AP 110-1 of FIG. 1) and occupies 8 MHz of bandwidth. The RU 1 (305-1) is followed by a frequency offset 1 (310-1). RU 2 is assigned to AP 2 (e.g., 110-2 of FIG. 2) and spans 20 MHz. The offset 1 (310-1) is located between RU 1 and RU 2 and spans 8 MHz. Following RU 2 and before RU 3, offset 2 (310-2) is 20 MHz. RU 3 (305-3) is assigned to AP 1 and occupies 8 MHz. RU 4 (305-4) is assigned to AP 2 and also occupies 8 MHz. Offset 3 (310-3), between RU 3 (305-3) and RU 4 (305-4), is 1 MHz. A remaining portion of the channel is unoccupied and may serve as padding or guard space for spectral isolation or future allocation.

Similar to the uniform interleaved RU configuration as depicted in FIG. 2, the non-uniform interleaved RU configuration also allows each AP to concentrate its transmit power into a smaller subset of the overall channel bandwidth, resulting in a higher per-RU power level under PSD limits. For example, in the illustrated example 300, AP 1 occupies two RUs, RU 1 and RU 3, with a combined bandwidth of 16 MHz. Under a PSD constraint (e.g., 5 dBm/MHz), AP 1 may transmit with up to 17 dBm total power across its assigned RUs. In contrast, an AP occupying the full 160 MHz channel would be limited to a total transmit power of 27 dBm. When this power is distributed across the entire channel, the resulting per-subcarrier (or per-RU) power is lower than that of the narrower allocation, leading to reduced link margin and shorter range. Therefore, by allocating fewer and selected placed RUs, an AP can enhance signal strength per subcarrier, and improve link budget and transmission range.

The distributed RU allocation within non-uniform RU sizes and variable offsets, as illustrated, may be applied to both DL and UL transmissions. In the DL direction, APs may coordinate to allocate RUs of varying sizes based on application demands and channel conditions. In the UL direction, such coordination may be informed by STA-side reporting, allowing the network to assign appropriate RU sizes and positions.

The RU sizes shown in FIG. 3, such as 8 MHz and 20 MHz, are provided for conceptual clarity. In some embodiments, RU size may vary and include other bandwidths such as 2 MHz, 4 MHz, 40 MHz, 80 MHz, or higher. The offset values shown, such as 1 MHz, 8 MHz, and 20 MHz, are provided as examples, and the actual spacing between RUs may vary based on spectrum availability, interference conditions, and scheduling algorithms.

The illustrated 160 MHz channel 315 is also an example provided for conceptual clarity. Coordinated distributed RU allocation schemes may be applied across any wide channel within the 6 GHz band or other applicable frequency bands.

In the example 300, AP 1 and AP 2 may correspond to AP 110-1 and AP 110-2 as depicted in FIG. 1, where each AP is connected to a different STA (e.g., STA 105-1 and STA 105-2 as depicted in FIG. 1). In some embodiments, AP 1 and AP 2 may represent separate APs or logical radios operating on different links to the same STA MLD.

Although the figure illustrates RU coordination between two APs, the disclosed RU coordination may be extended to three or more APs, to further optimize spatial reuse and spectral efficiency.

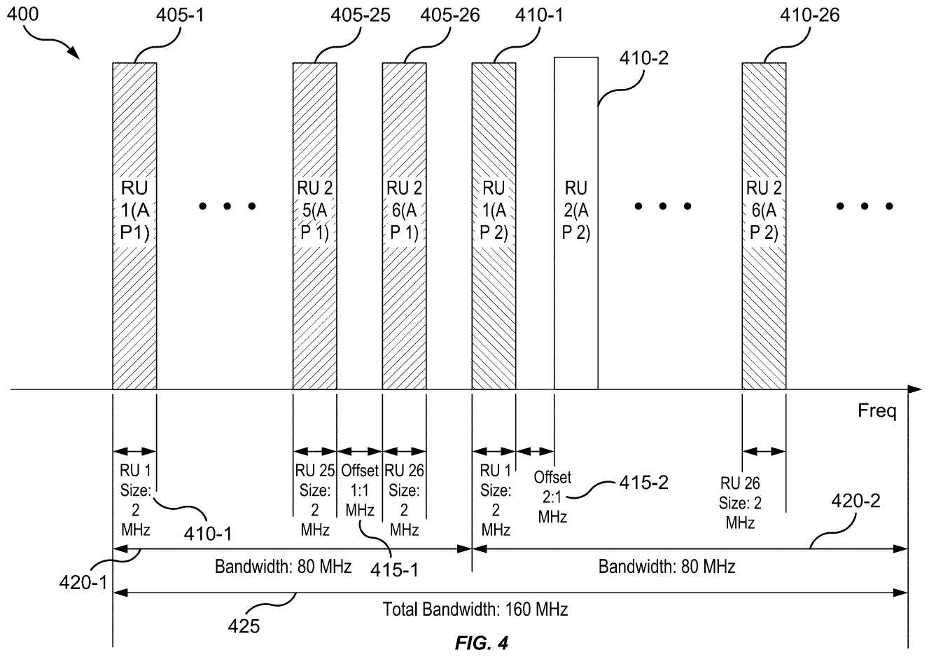

FIG. 4 depicts an example of skewed RU allocation 400 across a 160 MHz channel between multiple access points (APs), according to some embodiments of the present disclosure.

In this example, the horizontal axis (x-axis) represents frequency, and a 160 MHz-wide channel 425 is depicted. The channel 425 is divided into two equal 80 MHz halves. The first half of the spectrum (0-80 MHz) 420-1 is occupied by AP 1, which may correspond to AP 110-1 of FIG. 1. AP 1 is assigned RU 1 (405-1) through RU 26 (405-26), with each RU occupying 2 MHz of bandwidth. The offset 415-1 between adjacent RUs, such as RU 25 (405-25) and RU 26 (405-26), is 1 MHz.

The second half of the spectrum (80-160 MHz) 420-2 is occupied by AP 2, which may correspond to AP 110-2 of FIG. 1. AP 2 is assigned RU 1 (410-1) through RU 26 (410-26), with each RU occupying 2 MHz of bandwidth. The offset 415-2 between adjacent RUs, such as RU 1 (405-1) and RU 2 (405-2), is 1 MHz.

The asymmetrical (or skewed) distribution of RUs across the channel allows each AP to operate within its dedicated frequency segment. Such distribution provides frequency-domain separation while still achieving effective RU utilization. The skewed pattern enables higher per-RU power under PSD limits and provides scheduling flexibility based on traffic demand, interference conditions, or the STA's proximity to each AP.

As discussed, AP 1 and AP 2 may communicate with different STAs, such as STA 105-1 and STA 105-2 as depicted in FIG. 1. In some embodiments, AP 1 and AP 2 may serve a non-AP MLD via separate links. Although FIG. 4 depicts coordination between two APs, the disclosed skewed RU allocation may be extended to support more than two APs. For example, in embodiments involving three APs, the channel may be divided into three non-overlapping frequency segments, each assigned to a respective AP for DL or UL transmission. The partition may be static or dynamically adjusted based on real-time factors such as traffic demand, link quality, or user density.

FIG. 4 illustrates uniform RU size (2 MHz) with a fixed 1 MHz offset across each AP's assigned portion. The depicted RU is provided for conceptual clarity. In some embodiments, the RUs assigned to APs may vary in size and spacing (e.g., a combination of 8 MHz and 4 MHz RUs separated by non-uniform offsets).

The disclosed skewed RU allocation may be applicable to both DL and UL transmissions. In the DL cases, the APs coordinate to allocate their respective RU subsets. In the UL cases, the RU requests or preferences may be reported by STAs and scheduled accordingly by the network.

The illustrated 160 MHz-wide channel 425 is an example provided for conceptual clarity. The disclosed RU coordination scheme may be implemented across any wideband channel within the 6 GHz band, such as 80 MHz, 240 MHz, or even larger.

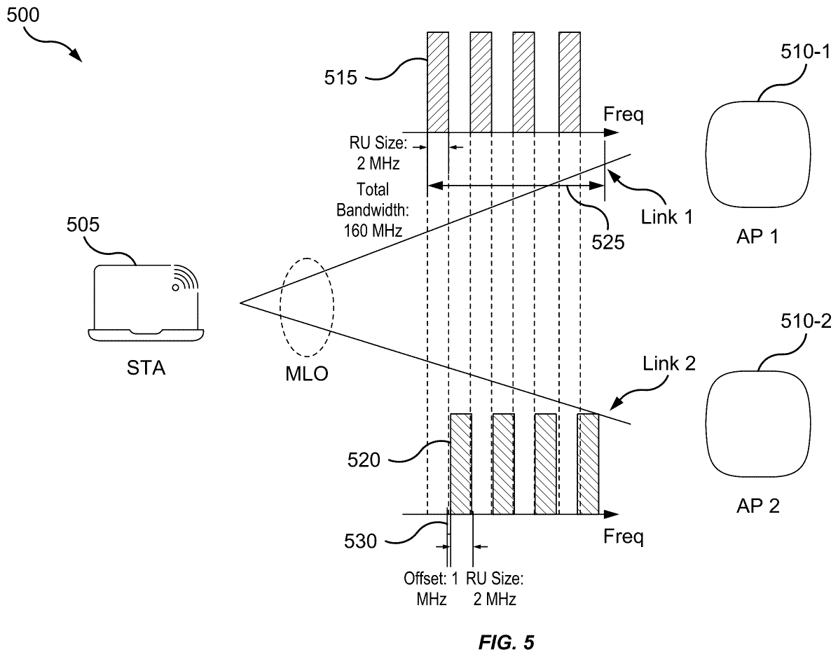

FIG. 5 depicts an example 500 of a multi-link device (MLD) station (STA) connecting to two APs via separate links, with coordinated RU allocation for data transmission, according to some embodiments of the present disclosure.

In the example 500, two APs 510 conduct coordinated DL transmission to a single STA MLD 505. As depicted, AP 1 (510-1) communicates with STA MLD 505 via link 1, and AP 2 communicates with STA MLD 505 via link 2, with both links operating in the 6 GHz frequency band. The available 160 MHz channel 525 is shared between the two APs using an interleaved RU allocation pattern, where each RU is 2 MHz wide, and the offset between adjacent RUs is 1 MHz. As depicted, RUs 515 assigned to AP 1 and RUs 520 assigned to AP 2 are arranged in an alternating pattern across the frequency channel.

The AP 1 (510-1) and AP 2 (510-2) may correspond to physically separate AP devices (e.g., AP 110-1 and AP 110-2 of FIG. 1), or to logical radio interfaces of a single AP MLD (such as different links supported within the same physical access point system). In either case, the coordinated RU allocation allows both entities to transmit to the same STA over different links.

The illustrated configuration supports several transmission modes. In some embodiments, the same data content may be transmitted by both AP 1 and AP 2 on their respective RUs. The redundant delivery across independent links increases transmission reliability. This mode may be suitable for applications where packet loss should be minimized (e.g., real-time control commands for AR/VR or industrial automation, safety-critical sensor data). Redundant delivery helps mitigate transient link degradation or interference by providing an alternative reception path.

In some embodiments, the two APs 510 may transmit segmented portions of a single data stream using interleaved RUs. For example, AP 1 sends the first portion of the stream, and AP 2 sends the next portion. The STA MLD 505 may receive data in parallel across both links and reconstruct the stream for upper layers. This mode uses the interleaved RU pattern for continuous flow and therefore improves the aggregate throughput.

In some embodiments, AP 1 and AP 2 may deliver independent traffic flows, such as data associated with different traffic identifiers (TIDs), Quality of Service (QoS) levels, or application types. This allows each link to be optimized for specific application requirements (e.g., video on one link, background sync on another). This mode also leads to more efficient link utilization and enhanced throughput.

These transmission modes are not mutually exclusive. Depending on link quality, channel conditions, or application requirements, the system may dynamically switch between these strategies or combine them in a hybrid mode.

The depicted RU allocation may also be applied to UL transmission, in addition to the DL scenarios illustrated. In the UL transmission, the STA MLD 505 may coordinate with multiple APs, such as AP 1 (510-1) and AP 2 (510-2), to transmit UL data in a distributed manner across a shared channel. For example, the STA MLD 505 may report its bandwidth and traffic requirements to each AP, and therefore enable the APs to cooperatively assign UL RUs across the channel to reduce interference and optimize power usage under PSD limits. The coordination may be facilitated through control signaling (e.g., trigger frames or UL scheduling frames).

Although the interleaved RU allocation with uniform RU size (e.g., 2 MHz) and fixed offset 530 (e.g., 1 MHz) in the illustrated example is discussed for conceptual clarity, in some embodiments, similar principles may be extended to more generalized RU layouts. For example, interleaved RU allocation with non-uniform RU sizes and offsets, or skewed RU distribution (e.g., one AP occupying the lower half of the spectrum, another the upper half), may also be used.

The specific RU sizes and offset values illustrated in the figures are provided as examples for conceptual clarity. In some embodiments, RU sizes may vary depending on traffic class, regulatory requirements, or channel conditions. Similarly, offsets between adjacent RUs may be fixed or variable, depending on the coordination scheme used.

The illustrated 160 MHz channel 525 within the 6 GHz band is depicted as an example, and the disclosed RU allocation strategies may be applied to any wideband channel suitable for multi-RU partitioning.

The STA MLD 505 may support more than two links, and may be connected to multiple APs or multiple radio interfaces of a single AP MLD. In such configurations, the RU coordination techniques described herein can be extended to support more than two AP entities for multi-link transmission scheduling across a broader spectrum.

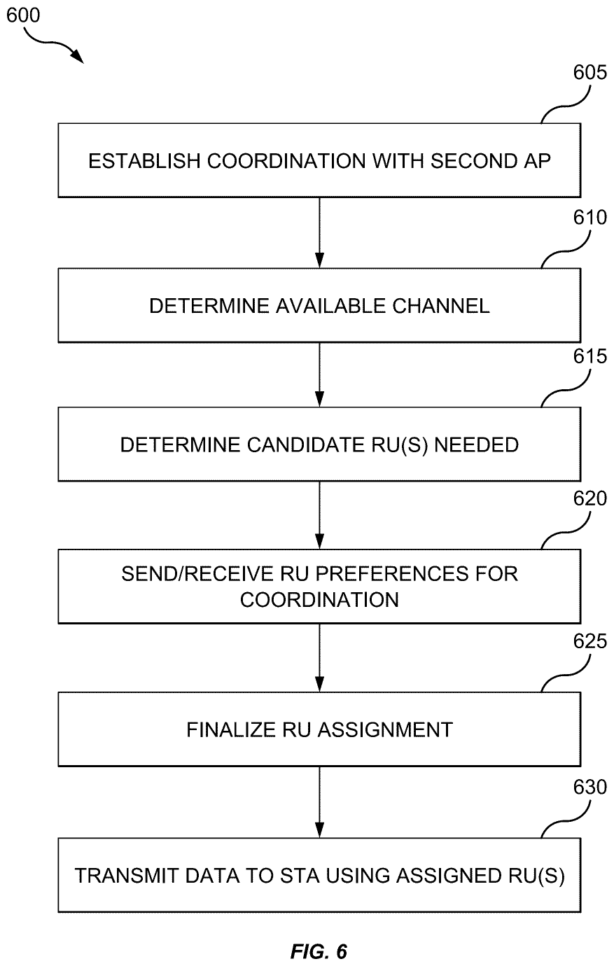

FIG. 6 depicts an example method 600 performed by a first AP (AP 1) for coordinating distributed RU allocation with a second AP (AP 2), according to some embodiments of the present disclosure. The first AP (AP 1) may correspond to AP 110-1 as depicted in FIG. 1, or any other network device capable of participating in coordinated RU scheduling and transmission (e.g., an AP in a MLD, or a logical radio within a virtualized AP platform).

At block 605, AP 1 establishes or joins a coordination mechanism with a second AP (e.g., AP 110-2 of FIG. 1). This process may include negotiating supported coordination protocols, discovering peer AP capabilities, and agreeing on a control channel or signaling framework for subsequent RU coordination. The mechanism may be established either over the air (e.g., using beacons, vendor-specific action frames, or other suitable management frames) or via a centralized entity like a WLC (e.g., 115 of FIG. 1).

At block 610, AP 1 determines the spectrum availability within the 6 GHz band, such as identifying a 160 MHz channel for coordination. Although the example focuses on the 6 GHz band, the disclosed distributed RU coordination may also be applied to other frequency bands (e.g., 5 GHz or higher), provided similar PSD constraints or coordination needs exist.

At block 615, based on the traffic demand, AP 1 determines the candidate RUs needed for data transmission. The number, size, and placement of these RUs may depend on current channel occupancy, target performance objectives (e.g., range vs. throughput), and STA capabilities.

At block 620, AP 1 exchanges RU preferences with AP 2 for coordination. AP 1 may either send its RU preferences to AP 2 (or the WLC), or receive coordination input from AP 2. In a peer-to-peer embodiment, AP 1 and AP 2 may negotiate RU allocation directly. In a centralized scenario, the WLC may aggregate RU preferences from multiple APs and resolve conflicts to produce a coordinated allocation.

At block 625, AP 1 finalizes its RU allocation and may transmit (or receive) confirmation messages or resource allocation descriptions to (or from) the second AP or the WLC. The agreed-upon RU distribution may adopt various patterns, such as interleaved RUs with fixed offset (as depicted in FIG. 2), interleaved RUs with non-uniform sizes and variable offset (as depicted in FIG. 3), or skewed RU allocation where each AP occupies a portion of the frequency band (as depicted in FIG. 4). The finalized allocation is then communicated to the second AP (or received from the second AP or the WLC). The information may include the specific RU sizes, offset schemes, and optional padding or guard band arrangement.

At block 630, AP 1 proceeds to transmit DL data to the associated STA using the allocated RUs. These transmissions occur concurrently with transmissions from the second AP (on its assigned RUs). The distributed RU usage improves spectral efficiency and extends communication range under the PSD limits.

Although the example method focuses on coordination between two APs, the method may be extended to include three or more APs, where each AP is assigned a non-overlapping segment of the spectrum. The cooperating APs may be serving separate STAs (e.g., STA 105-1 and STA 105-2 of FIG. 1), each with its own throughput and range requirements, or a single multi-link STA over separate raid links (e.g., Link 1 and Link 2 of FIG. 5).

In coordinated DL to a single AP, different data transmission strategies may be used. In one embodiment, the two APs may transmit redundant data over separate RUs to the STA to improve transmission reliability. In another embodiment, the two APs may transmit segmented portions of a larger data stream, which enables the STA to receive different fragments in parallel and reassemble them to improve aggregated throughput. In another embodiment, each AP may be assigned different traffic types, such as different TIDs or QoS categories, allowing independent transmission streams that reflect differentiated service priorities.

Although the depicted example method focuses on DL transmission, similar RU coordination may also be applied to UL transmissions. In such configurations, additional procedures may be required. STAs may report their buffer status and transmission capability to associated APs. APs may then coordinate for distributed RU allocation and manage data reception.

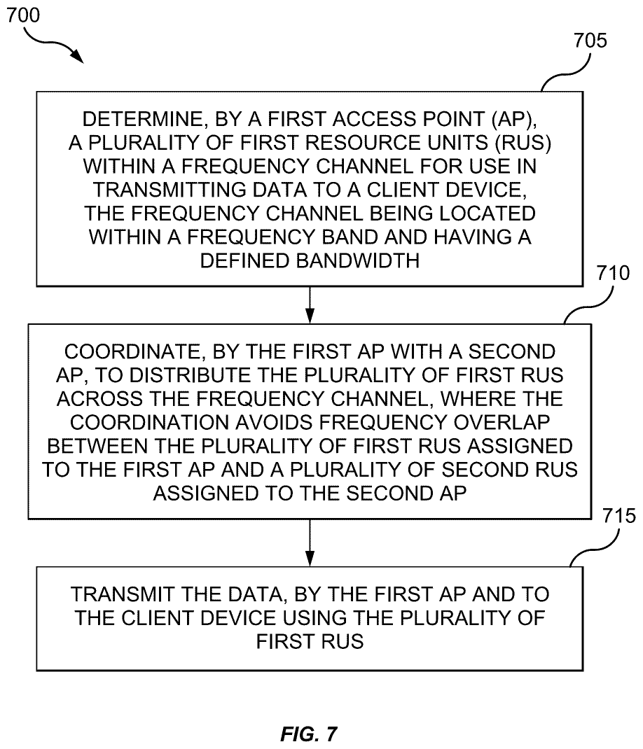

FIG. 7 is a block diagram depicting an example method 700 for RU coordination between multiple APs within a shared frequency band, according to some embodiments of the present disclosure.

At block 705, a first AP (e.g., AP 110-1 of FIG. 1) determines a plurality of first resource units (RUs) within a frequency channel (e.g., 160 MHz-wide channel 215 as depicted in FIG. 2) for use in transmitting data to a client device (e.g., STA 105-1 of FIG. 1), the frequency channel being located within a frequency band (e.g., 6 GHz frequency band) and having a defined bandwidth (e.g., 160 MHz).

At block 710, the first AP coordinates with a second AP (e.g., AP 110-2 of FIG. 1) to distribute the plurality of first RUs across the frequency channel, where the coordination avoids frequency overlap between the plurality of first RUs assigned to the first AP and a plurality of second RUs assigned to the second AP.

At block 715, the first AP transmits the data to the client device using the plurality of first RUs.

In some embodiments, each of the plurality of first RUs may have a fixed bandwidth (e.g., 2 MHz as depicted in FIG. 2). The plurality of first RUs and the plurality of second RUs may be assigned in an interleaved pattern across the frequency channel, with a fixed frequency offset (e.g., 1 MHz as depicted in FIG. 2) between adjacent RUs assigned to the first AP and the second AP.

In some embodiments, the plurality of first RUs assigned to the first AP may have non-uniform bandwidth (e.g., 8 MHz and 20 MHz as depicted in FIG. 3) and the plurality of first RUs and the plurality of second RUs may be assigned in an interleaved pattern across the frequency channel, with a non-uniform frequency offset (e.g., 8 MHz, 20 MHz, and 1 MHz as depicted in FIG. 3) between adjacent RUs assigned to the first AP and the second AP, where the non-uniform frequency offset varies in accordance with a coordination scheme between the first and second APs.

In some embodiments, the client device may comprise a distributed multi-link device (MLD) comprising a first link (e.g., Link 1 of FIG. 5) and a second link (e.g., Link 2 of FIG. 5), and the first link may be connected to the first AP and the second link may be connected to the second AP, where the second AP transmits to the client device over the second link using the plurality of second RUs.

In some embodiments, the first AP and second AP may each transmit duplicated traffic to the client device over the respective plurality of first RUs and second RUs.

In some embodiments, the first AP may transmit a first portion of a data stream to the client device over the first link using the plurality of first RUs, the second AP may transmit a second portion of the data stream to the client device over the second link using the plurality of second RUs, and the client device may be configured to combine the first portion and the second portion in a defined sequence to reconstruct the data stream.

In some embodiments, the first AP and second AP may each transmit data of different traffic types to the client device over the respective plurality of first RUs and second RUs, and the data of different traffic types may be independently received over the respective first and second links to increase a total throughput of the client device.

In some embodiments, the plurality of first RUs assigned to the first AP may be distributed within a first portion of the frequency channel, the plurality of second RUs assigned to the second AP may be distributed within a second portion of the frequency channel, and the first and second portions do not overlap.

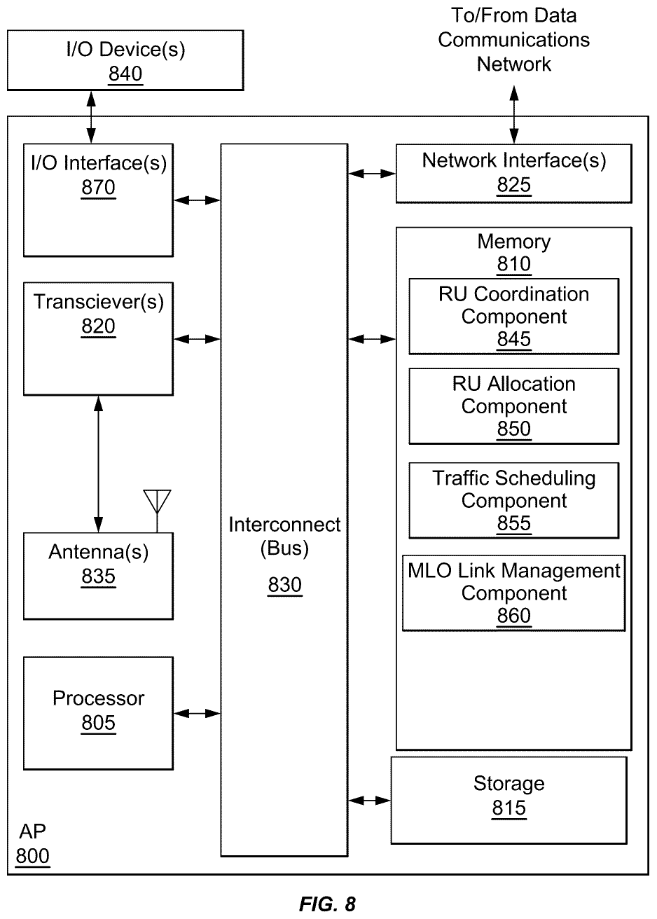

FIG. 8 depicts an example network device 800 configured to perform various aspects of the present disclosure, according to some aspects of the present disclosure. The example network device 800 may correspond to the APs 110-1 and 110-2 as depicted in FIG. 1, or any other network device capable of participating in coordinated RU scheduling and transmission (e.g., an AP of a MLD, or logical radio within a virtualized AP platform).

As illustrated, the network device 800 includes a processor 805, memory 810, storage 815, one or more transceivers 820, one or more I/O interfaces 880, and one or more network interfaces 825. In some embodiments, I/O devices 870 are connected via the I/O interface(s) 880. Further, via the network interface 825, the network device 800 can be communicatively coupled with one or more other devices and components (e.g., via a network, which may include the Internet, local network(s), and the like). Each of the components is communicatively coupled by one or more buses 830. In some embodiments, one or more antennas 835 may be coupled to the transceivers 820 for transmitting and receiving wireless signals.

The processor 805 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 805 processes information received through the transceiver 820, I/O interfaces 880, and the network interfaces 825. The processor 805 retrieves and executes programming instructions stored in memory 810, as well as stores and retrieves application data residing in storage 815.

The storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 815 may store a variety of data for the efficient functioning of the system.

The memory 810 may include random access memory (RAM) and read-only memory (ROM). The memory 810 may store processor-executable software code containing instructions that, when executed by the processor 805, enable the network device 800 to perform various functions described herein for wireless communication. The memory 810 includes a RU coordination component 845, a RU allocation component 850, a traffic scheduling component 855, and a MLO link management component 860.

In one embodiment, the RU coordination component 845 is configured to handle the negotiation and exchange of RU usage preference or availability information with other APs or with a WLC. The RU coordination component 845 may support OTA coordination using management or action frames, or centralized coordination through backhaul signaling.

In one embodiment, the RU allocation component 850 is configured to determine the subset of RUs to request or offer, based on local throughput demand, channel conditions, PSD constraints, and regulatory requirements. The RU allocation component 850 may also select parameters such as RU size, location in the frequency domain, and offset from neighboring RUs.

In one embodiment, the traffic scheduling component 855 is configured to map higher-layer traffic flows (e.g., categorized by TID or QoS priority) to the coordinated RU structure.

In implementations where the network device 800 supports multi-link operation (MLO), the memory may further include a MLO link management component 860, which manages separate physical or logical links to the same STA MLD. The component 860 coordinates transmission strategies across links, whether for redundant, segmented, or independent traffic delivery, and ensures link-level synchronization and buffer management.

Although depicted as a discrete component for conceptual clarity, in some embodiments, the operations of the depicted components (and others not illustrated) may be combined or distributed across any number of components. Further, although depicted as software residing in memory 810, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
determining, by a first access point (AP), a plurality of first resource units (RUs) within a frequency channel for use in transmitting data to a client device, the frequency channel being located within a frequency band and having a defined bandwidth;
coordinating, by the first AP with a second AP, to distribute the plurality of first RUs across the frequency channel, wherein the coordination avoids frequency overlap between the plurality of first RUs assigned to the first AP and a plurality of second RUs assigned to the second AP; and
transmitting the data, by the first AP and to the client device, using the plurality of first RUs.

2. The method of claim 1, wherein:
each of the plurality of first RUs has a fixed bandwidth, and
the plurality of first RUs and the plurality of second RUs are assigned in an interleaved pattern across the frequency channel, with a fixed frequency offset between adjacent RUs assigned to the first AP and the second AP.

3. The method of claim 1, wherein:
the plurality of first RUs assigned to the first AP have non-uniform bandwidth, and
the plurality of first RUs and the plurality of second RUs are assigned in an interleaved pattern across the frequency channel, with a non-uniform frequency offset between adjacent RUs assigned to the first AP and the second AP, wherein the non-uniform frequency offset varies in accordance with a coordination scheme between the first and second APs.

4. The method of claim 1, wherein:
the client device comprises a distributed multi-link device (MLD) comprising a first link and a second link, and
the first link is connected to the first AP, and the second link is connected to the second AP, wherein the second AP transmits to the client device over the second link using the plurality of second RUs.

5. The method of claim 4, wherein the first AP and second AP each transmit duplicated traffic to the client device over the respective plurality of first RUs and second RUs.

6. The method of claim 4, wherein:
the first AP transmits a first portion of a data stream to the client device over the first link using the plurality of first RUs,
the second AP transmits a second portion of the data stream to the client device over the second link using the plurality of second RUs, and
the client device is configured to combine the first portion and the second portion in a defined sequence to reconstruct the data stream.

7. The method of claim 4, wherein:
the first AP and second AP each transmit data of different traffic types to the client device over the respective plurality of first RUs and second RUs, and
the data of different traffic types are independently received over the respective first and second links to increase a total throughput of the client device.

8. The method of claim 1, wherein:
the plurality of first RUs assigned to the first AP are distributed within a first portion of the frequency channel,
the plurality of second RUs assigned to the second AP are distributed within a second portion of the frequency channel, and
the first and second portions do not overlap.

9. A system of a first access point (AP), comprising:
one or more memories collectively containing one or more programs; and
one or more processors, wherein the one or more processors are configured to, individually or collectively, perform an operation comprising:
determining, by a first access point (AP), a plurality of first resource units (RUs) within a frequency channel for use in transmitting data to a client device, the frequency channel being located within a frequency band and having a defined bandwidth;
coordinating, by the first AP with a second AP, to distribute the plurality of first RUs across the frequency channel, wherein the coordination avoids frequency overlap between the plurality of first RUs assigned to the first AP and a plurality of second RUs assigned to the second AP; and
transmitting the data, by the first AP and to the client device, using the plurality of first RUs.

10. The system of claim 9, wherein:
each of the plurality of first RUs has a fixed bandwidth, and
the plurality of first RUs and the plurality of second RUs are assigned in an interleaved pattern across the frequency channel, with a fixed frequency offset between adjacent RUs assigned to the first AP and the second AP.

11. The system of claim 9, wherein:
the plurality of first RUs assigned to the first AP have non-uniform bandwidth, and
the plurality of first RUs and the plurality of second RUs are assigned in an interleaved pattern across the frequency channel, with a non-uniform frequency offset between adjacent RUs assigned to the first AP and the second AP, wherein non-uniform frequency offset varies in accordance with a coordination scheme between the first and second APs.

12. The system of claim 9, wherein:
the client device comprises a distributed multi-link device (MLD) comprising a first link and a second link, and
the first link is connected to the first AP and the second link is connected to the second AP, wherein the second AP transmits to the client device over the second link using the plurality of second RUs.

13. The system of claim 12, wherein the first AP and second AP each transmit duplicated traffic to the client device over the respective plurality of first RUs and second RUs.

14. The system of claim 12, wherein:
the first AP transmits a first portion of a data stream to the client device over the first link using the plurality of first RUs,
the second AP transmits a second portion of the data stream to the client device over the second link using the plurality of second RUs, and
the client device is configured to combine the first portion and the second portion in a defined sequence to reconstruct the data stream.

15. The system of claim 12, wherein:
the first AP and second AP each transmit data of different traffic types to the client device over the respective plurality of first RUs and second RUs, and
the data of different traffic types are independently received over the respective first and second links to increase a total throughput of the client device.

16. The system of claim 9, wherein:
the plurality of first RUs assigned to the first AP are distributed within a first portion of the frequency channel,
the plurality of second RUs assigned to the second AP are distributed within a second portion of the frequency channel, and
the first and second portions do not overlap.

17. One or more non-transitory computer-readable media containing, in any combination, computer program code that, when executed by operation of a computer system, performs operations comprising:
determining, by a first access point (AP), a plurality of first resource units (RUs) within a frequency channel for use in transmitting data to a client device, the frequency channel being located within a frequency band and having a defined bandwidth;
coordinating, by the first AP with a second AP, to distribute the plurality of first RUs across the frequency channel, wherein the coordination avoids frequency overlap between the plurality of first RUs assigned to the first AP and a plurality of second RUs assigned to the second AP; and
transmitting the data from the first AP to the client device using the plurality of first RUs.

18. The one or more non-transitory computer-readable media of claim 17, wherein:
each of the plurality of first RUs has a fixed bandwidth, and
the plurality of first RUs and the plurality of second RUs are assigned in an interleaved pattern across the frequency channel, with a fixed frequency offset between adjacent RUs assigned to the first AP and the second AP.

19. The one or more non-transitory computer-readable media of claim 17, wherein:
the plurality of first RUs assigned to the first AP have non-uniform bandwidth, and
the plurality of first RUs and the plurality of second RUs are assigned in an interleaved pattern across the frequency channel, with a non-uniform frequency offset between adjacent RUs assigned to the first AP and the second AP, wherein non-uniform frequency offset varies in accordance with a coordination scheme between the first and second APs.

20. The one or more non-transitory computer-readable media of claim 17, wherein:
the plurality of first RUs assigned to the first AP are distributed within a first portion of the frequency channel,
the plurality of second RUs assigned to the second AP are distributed within a second portion of the frequency channel, and
the first and second portions do not overlap.
